(19) United States
(12) Patent Application Publication
(10) Pub. No.: US 2006/0164418 A1
(43) Pub. Date: Jul. 27, 2006

(54) Method and system for automated visualization using common scale

(76) Inventors: Ming C. Hao, Palo Alto, CA (US); Umeshwar Dayal, Saratoga, CA (US); Adrian Krug, Duesseldorf (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/044,705

(22) Filed: Jan. 25, 2005

(51) Int. Cl. G06T 11/20

(52) U.S. Cl. 345/440; 345/440.2

(57) ABSTRACT

Embodiments include methods and systems for automated visualization using a common scale. One embodiment is a computer method for presenting data. The method computes a multi-level hierarchical structure for data and a common color scale for the multi-level hierarchical structure. Pixels are used to represent data records in the multi-level hierarchical structure. Different levels of the multi-level hierarchical structure are compared using the common color scale to visually identify a cause of performance delays.

### BACKGROUND

Business data is a source of valuable information and can provide a competitive advantage if the data can be quickly and accurately analyzed. Finding valuable information hidden in large amounts of data, though, can be quite challenging since such information is concealed in the data. Visual data comparison techniques can be extremely useful for revealing such valuable information hidden in data.

Prior visual data comparison techniques include simple graphical techniques, such as bar charts, pie charts, and x-y charts. These simple graphical techniques are easy to use but offer limited information, especially for visually evaluating large amounts of business data. For example, simple bar charts or pie charts show highly aggregated data while simultaneously omitting many other data values, such as data distribution of multiple attributes, patterns in data, correlations, or other detailed information.

As one example, visual data comparison techniques can be valuable in distributed enterprise applications that utilize multiple independent backend systems. In such enterprises, performance problems or delays, such as time delays for certain applications, can be sporadic and inconsistent. Discovering the root cause of such delays can be difficult and time consuming since vast amounts of data are required to produce sufficient log records. Significant benefits, however, can be realized if the performance problems can be quickly and easily identified.

### SUMMARY

Embodiments include methods and systems for automated visualization using a common scale. One embodiment is a computer method for presenting data. The method computes a multi-level hierarchical structure for data and a common color scale for the multi-level hierarchical structure. Pixels are used to represent data records in the multi-level hierarchical structure. Different levels of the multi-level hierarchical structure are compared using the common color scale to visually identify a cause of performance delays.

In another exemplary embodiment, computer-readable program code causes a computer system to perform a method of displaying data. The method includes computing plural hierarchical graphs for data; arranging, using pixels, the data in the plural hierarchical graphs, with each pixel encoded with a portion of the data; computing a color scale that is common for the plural hierarchical graphs; and displaying the plural graphs, using the pixels and common color scale, to illustrate time-related performance delays in the data.

Other embodiments and variations of these embodiments are shown and taught in the accompanying drawings and detailed description.

### BRIEF DESCRIPTION OF THE DRAWINGS

FIG. 1 is a flow diagram of an embodiment in accordance with the present invention.

FIG. 2 shows an X-Y graph of an embodiment in accordance with the present invention.

FIG. 3A is an example of a common scale.

FIG. 3B is another example of a common scale.

FIG. 4 is an X-Y graph of one layer of the graph of FIG. 2.

FIG. 5 is an X-Y graph of another layer of the graph of FIG. 2.

FIG. 6 is an X-Y graph of another layer of the graph of FIG. 2.

### DETAILED DESCRIPTION

In an exemplary embodiment, the present invention is directed to visual data comparison techniques for quickly and easily comparing, analyzing, and/or revealing information in large amounts of data. Embodiments in accordance with the invention, for example, can be utilized to visualize valuable information concealed in vast amounts of data, such as business data. As one example, differences, changes, sporadic and/or inconsistent problems, or trends in large amounts of data can be distilled to be quickly and easily visually apparent.

Embodiments in accordance with the present invention provide visual data comparison techniques that can be utilized in a wide variety of systems, methods, and apparatus. Examples include distributed enterprise applications that utilize multiple independent backend systems. In such enterprises, performance problems or delays, such as time delays for certain applications, can be sporadic and inconsistent. Embodiments in accordance with the invention can discover the cause or causes (such as the root cause) of such delays even though such causes are concealed within vast amounts of data. Further, details of individual data records can be quickly obtained using pixels.

One embodiment computes a multi-layered graphical hierarchical data structure with an automated common scale (such as a color scale) constructed from vast amounts of input data. The multiple layers enable a user to visually identify the root cause of a sporadic problem in extremely large data. Pixels in the graphical illustration represent a data item that enables the visualization of large volume of data. The input data is divided into a hierarchical structure with multiple layers that visually present the root cause of a problem. A consistent or common scale (such as a color scale) is used through the layers.

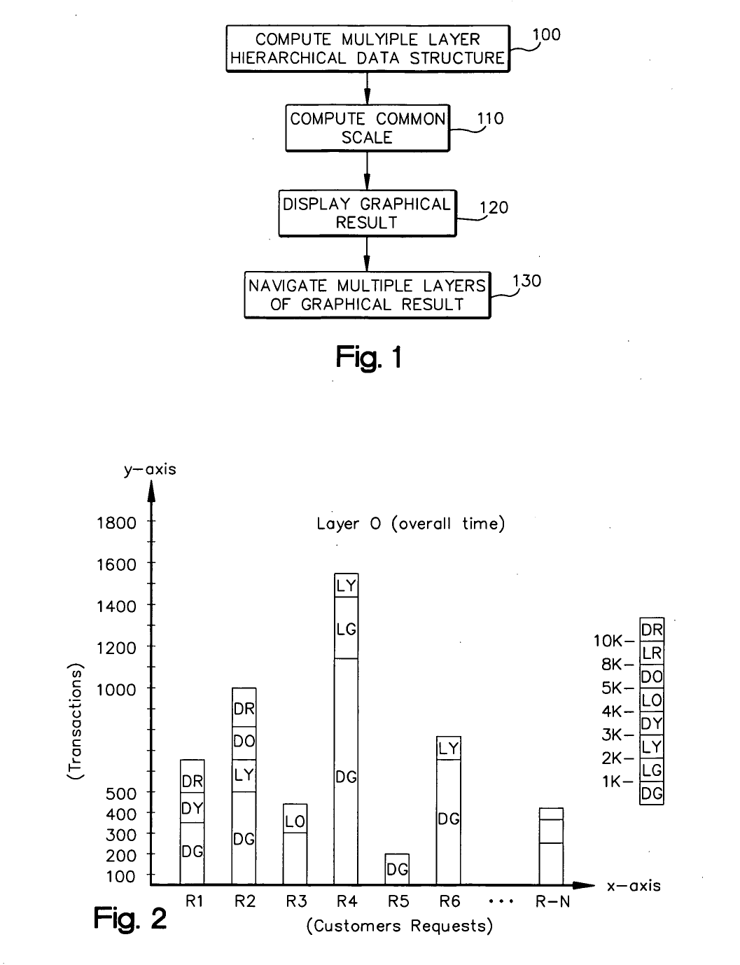

FIG. 1 shows an exemplary flow diagram in accordance with embodiments of the present invention. The flow diagram is discussed with references to exemplary embodiments shown in FIGS. 2-6.

Per block 100, a multiple layer or multiple level hierarchical data structure is computed. From large amounts of data, individual execution timings are captured for each independent layer/backend system of the enterprise application. The captured data is constructed or computed into a hierarchical format and displayed in a graph, such as an X-Y graph.

FIG. 2 shows an exemplary X-Y graph for presenting the captured data. The X and Y axes can represent a category, transaction, application, time, etc. For example the X-axis represents customer or user requests. For illustration, various requests (R1, R2, R4, . . . R-N) are shown. The Y-axis represents ordering or positioning. For illustration, the Y-axis represents the number of transactions for each request of the X-axis. The X and Y axes could be any increment.

In one exemplary embodiment, the hierarchical data structure is broken down or divided into multiple layers or stages, such as layers L0, L1, L2, . . . L-N. Each layer is assigned a different visual designation, such as a different color (color0, color1, color2, . . . color-N). Thus, the number of colors is based on the number of different layers in the hierarchical structure: color0 for Layer0, color1 for Layer1, . . . colorN for LayerN. Further, the color of each layer represents a value of a metric. FIGS. 4-6 show examples for layers L1, L2, and LN.

For illustration purposes, the X-axis represents the request/transaction of the application that has been executed, and the Y-axis represents the number of transactions. The graph of Layer0, thus, presents an X-Y graph for visually comparing the number of transactions (Y-axis) for each request (X-axis). As shown, for example, R4 had the most transactions (about 1600), and R5 had the least transactions (about 200).

As noted, the hierarchical data structure can be divided into multiple layers (L1, L2, . . . L-N). For illustrative purposes, L0 represents a base layer for graphically presenting a visual comparison and analysis. Each layer has its own set of data and is presented separately in its own graphical illustration. Thus, the overall time (Layer0) can be divided so that each of the other layers (L1, L2, . . . L-N) represents an individual component of the hierarchical data structure or application. For example, layers L1 to L-N can be subsets of L0. In other embodiments, each category (i.e., requests R1, R2, . . . R-N) can be divided or separated in to various layers or stages (i.e., layers L1, L2, . . . L-N).

Per block 110, a common scale is computed. The common scale represents the scale for all shared data. The common scale provides a scale that is consistent across multiple layers, such as all layers L1, L2, . . . L-N. Data within each respective layer can be compared via a common scale.

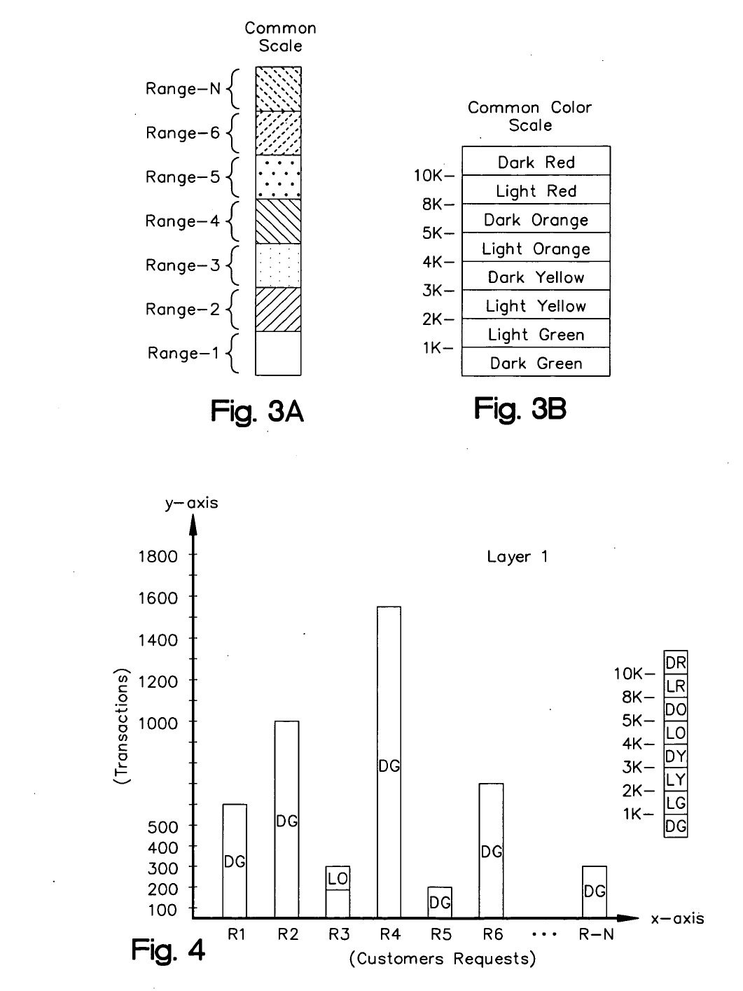

FIGS. 3A and 3B illustrate exemplary common scales. A common scale can be generated with a variety of symbols, letter, markings, colors, indicia, etc. In FIG. 3A, the scale is divided into a plurality of ranges (Range1, Range2, . . . Range-N). Each range has a different visual identification or marking. For example, Range1 has no lines; Range2 has parallel lines; Range3 has dots, etc.

FIG. 3B shows another example of a common scale that uses color. The scale is divided into eight different regions or ranges (arbitrarily shown as 1k, 2k, . . . 10k). Each range has a unique color. The colors of the scale range from dark green to dark red. Such colors are exemplary, and any color, or even colors in combination with markings or indicia, can be utilized. In FIGS. 2, 4, 5, and 6, a common color scale is used with the following color notations: DG is dark green, LG is light green, LY is light yellow, DY is dark yellow, LO is light orange, DO is dark orange, LR is light red, and DR is dark red.

In FIGS. 3A and 3B, the scales can span a predefined range. For example, this range could start at a minimum value and extend to a maximum value. FIG. 3B provides specific numbers for illustrative purposes. Here, the minimum value is 1000 (1k) and a maximum value is 10,000 (10k). The numbers and/or ranges can correspond to any categorical designation, such as time (picoseconds, nanosecond, microsecond, millisecond, second, minute, etc.).

Per block 120, graphical results are displayed. Thereafter, per block 130, a user can navigate through the various multiple layers to visually identify the cause or causes (such as the root cause) of delays or other problems. A user, for example, can drilldown on pixels to get detail records.

FIG. 2 represents a base graph (Layer0: Overall Time), and FIGS. 4-6 represent sub-graphs of FIG. 2. As shown in FIG. 2, a common color scale is used to visually depict execution time for the customer requests (i.e., R1, R2, . . . R-N). For example, customer requests R1 and R2 have dark red areas that signify significant execution time delays. A larger dark red area in a bar signifies that more transactions experienced time delays equivalent to the range associated with dark red color (i.e., 10k or over, as shown in the common color scale adjacent the X-Y graph in FIG. 2). By contrast, R5 has no time delays since its color is dark green. R4 and R6 have mild time delays.

Although FIG. 2 shows the occurrence or existence of time delays for each bar (i.e., for each request in the X-axis), the visual information presented in FIG. 2 is not sufficient to illustrate where such delays occur. In other words, FIG. 2 does not show in what layer or level of the application delays are occurring. For instance, significant execution or time delays occur in R1 and R2, but the graphical illustration of FIG. 2 does not indicate where such execution or time delays occur. The location of these delays is provided in the sub-graphs or multiple layers (L1, L2, . . . L-N) with the use of a common color scale.

As noted, the base graph is divided into a number of layers or sub-graphs. Each layer or sub-graph can represent a portion of the base graph. For instance, each transaction in the X-axis can be divided into an equal number of layers with the base graph representing a total or culmination of all the layers. Suppose, for example, that each request (i.e., R1, R2, . . . R-N) in the X-axis is broken down into four different layers. The base layer would represent or visually illustrate with color in the bars the overall time for each request. Color would be used in the sub-graphs or layers to represent the time for that particular layer to execute. Layer1, then, would illustrate the execution time for each request in this layer; layer2 would illustrate the execution time for each request in this layer; etc. If the layers are visually depicted with a common color scale, then a visual comparison can be made to determine the execution time or performance for each request in each layer. Time or performance delays are visually depicted. Further, the magnitude of such time or performance delays is visually depicted per the ranges (example different colors) in the common color scale.

FIG. 4 represents the first layer (Layer1) of the base graph (Layer0). Each transaction (i.e., requests R1, R2, . . . R-N) is represented with a common color scale. As shown, each request has a color of dark green (DG). Per the common color scale, DG does not represent a time delay (DG being less than 1k). Therefore, FIG. 4 shows that the first layer (Layer1) is not the cause of time delays for any of the requests.

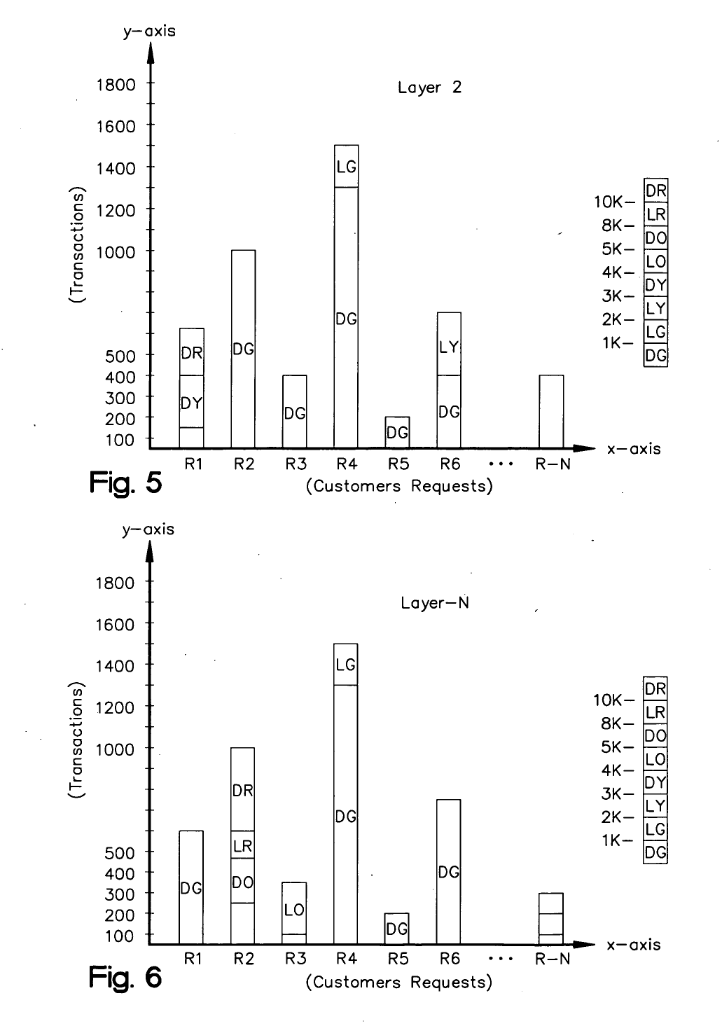

FIG. 5 represents a second layer (Layer2) of the base graph (Layer0). In this figure, one can visually identify that significant time delays are occurring for R1 in Layer2. Specifically, the bar of R1 has a top portion of dark red (DR, being greater than 10k). This color, per the common color scale, signifies that the time delay occurs in this layer or stage. If R1 were an application, then FIG. 5 visually shows that performance delays or time delays occur at this stage or layer of the application.

FIG. 5 further shows that the time delay for R2 is not occurring in Layer2 since the color of the bar for R2 is dark green (DG, being less than 1k). As such, the time delay for R2 must be occurring in another layer. Per the common color scale, FIG. 5 further shows that no time delay occurs for R3 or R5, and minor time delays occur for R4 and R6.

FIG. 6 represents the Nth layer (Layer-N) of the base graph (Layer0). In this figure, one can visually identify that significant time delays are occurring for R2 in Layer-N. Specifically, the bar for R2 has a top portion of dark red (DR), light red (LR), and dark orange (DO). These colors, per the common color scale, signify that significant time delays occur for R2 at this layer.

The graphs of the various layers can, thus, illustrate locations of performance problems, such as sporadic or inconsistent time delays in distributed enterprise applications.

The multi-layered graphs can be constructed and presented in a pixel-oriented layout to enable instant-drilldown to each layer as needed. A pixel, for example, can represent a data record. Further, the color of a pixel can represent the value of a data item.

FIGS. 2-6 illustrate one exemplary embodiment as a multi-level hierarchical structure. This structure, for example, may be embodied in various systems, methods, and/or apparatus. The structure provides a visual comparison of data using multi-level hierarchical graphical illustrations. Various different types of graphs or other different visualization techniques or visual data comparison techniques can be utilized and still be within the scope of the invention. Further, embodiments within the invention are applicable to various types of data and are not limited to, for example, business data.

The data can be computed or divided into a hierarchical structure having a plurality of different levels. These levels can vary in type, number, or degree, just to name a few examples. In one exemplary embodiment, the hierarchical structure a base graph is divided into a plurality of sub-graphs that utilize a common scale. The visual comparisons (example, L0, L1, . . . L-N) are automatically constructed or generated based on user input information or specified user drilldown sequences, choices, or selections.

The term “drilldown” or “drill down” (or variations thereof) is used when referring to moving down through a hierarchy of folders and/or files in a file system like that of Windows. The term may also mean clicking, selecting, and/or navigating through a series of dropdown menus or graphical illustrations in a graphical user interface. Drilldown layers, for example, allow the user to explore the graphical illustration in a hierarchical manner by pointing, clicking, and/or selecting on the part of the graphical illustration where more detail is needed but illustrate an exemplary embodiment for discussion. Further, preferably, graphical illustrations (such as the multiple layers, Layer0, Layer1, . . . Layer-N) are computed in real-time for presentation to the user via, for example, a graphical user interface.

The figures are intended to be illustrative in nature. As such, specific numerical data values (such as specific quantities, numbers, categories, etc.) or other specific information should be interpreted as illustrative for discussing exemplary embodiments. Such specific information is not provided to limit the invention. Further, although bars are used in the graphs, other graphical illustrations can also be used.

In an exemplary embodiment, each bar of FIGS. 2-6 is a pixel type bar. The pixel bars represent additional information with variations in, for example, color or graphical or textual distinctions. In the graphs, the X-axis represents a transaction; the Y-axis represents a number of transactions; and color represents time for transactions to execute. Of course, representations in the X and Y axes could be switched or altered and still be within the scope of embodiments in accordance with the invention.

Each pixel can be arranged in a variety of ways. For example, pixels can be arranged from bottom to top and left to right in each bar. Further, information (such as execution time) can be encoded in each pixel and represented, for example, as a color or other graphical representation. As one example, each individual transaction in each layer can be represented with a pixel. The amount of time for each transaction to execute can be encoded into the pixel. Further, the color of the pixel can correlate to a common color scale. Thus, higher bars in the graph have more pixels (i.e., more transactions). Likewise, more red pixels in the bar indicate more performance delays, and more green pixels in the bar indicate no performance delays. A user could also “click” or otherwise activate any individual pixel and get specific information or data regarding the individual transaction.

Further, it should be noted that the display of graphical results is not limited to single illustrations. In other words, multiple illustrations can simultaneously be displayed to the user. For example, the graphical illustrations of FIGS. 2 and 4-6 can simultaneously be displayed to the user on a single display or on multiple displays.

Further, a user can repeatedly drilldown throughout the multi-level hierarchical structure. A drilldown, for example, can occur to visually identify comparison results or deviations within the data. As such, exemplary embodiments of the present invention show not only visualizing changes in aggregation data, but also show visualizing the differences in data distribution while navigating or drilling-down through the data or viewing multiple different layers of a base graph. It should be noted that the comparison techniques are not limited to pixel bar charts or any specific type of graphical representation. The comparison techniques can be utilized with various graphical tools, such as bar charts, pie charts, and/or parallel coordinates, to name a few examples.

As noted various graphical illustrative formats can be used with embodiments of the present invention. Pixel bar charts are one such format. In a pixel bar chart, data values can be directly presented instead of aggregated into several data values. Each data item is represented by a single pixel in the bar chart. The detailed information of a single attribute for each data item is encoded into the pixel (for example, into the pixel color). The data can then be displayed and accessed.

Pixel bar charts can be defined or specified with five tuples or attributes (such as pixel object, dividing attribute, Y-ordering attribute, X-ordering attribute, and coloring attribute). Embodiments in accordance with the present invention can also utilize multi-pixel bar charts. Multi-pixel bar charts use different color mappings with the same partitioning and ordering attributes. In other words, different attributes are mapped to different colors. Preferably, each pixel is located at the same relative location across all pixel bar charts. At the same time though, each pixel shows a different attribute (such as number of transactions, quantities, locations, time to execute, etc.). In turn, the color of each pixel varies according to the value of the corresponding attribute. The user can activate (such as “click-on”) a pixel to get the corresponding attribute value.

Embodiments in accordance with the present invention can be utilized for visualization of multidimensional data sets using multiple pixel bar charts and other embodiments using pixel bar charts. As such, United States Publication No. 2003/0071815 A1 (Pub. Date: Apr. 17, 2003) and entitled “Method for Placement of Data for Visualization of Multidimensional Data Sets Using Multiple Pixel Bar Charts” is fully incorporated herein by reference.

In the various embodiments in accordance with the present invention, embodiments are implemented as one or more computer software programs. The software may be implemented as one or more modules (also referred to as code subroutines, or “objects” in object-oriented programming). The location of the software (whether on the client computer or elsewhere) will differ for the various alternative embodiments. The software programming code, for example, can be accessed by a processor of a computer or a server from long-term storage media of some type, such as a CD-ROM drive or hard drive. The software programming code may be embodied or stored on any of a variety of known media for use with a data processing system or in any memory device such as semiconductor, magnetic and optical devices, including a disk, hard drive, CD-ROM, ROM, etc. The code may be distributed on such media, or may be distributed to users from the memory or storage of one computer system over a network of some type to other computer systems for use by users of such other systems. Alternatively, the programming code may be embodied in memory, and accessed by one or more processors using a bus. The techniques and methods for embodying software programming code in memory, on physical media, and/or distributing software code via networks are well known and will not be further discussed herein.

Further, embodiments in accordance with the invention are not restricted to any particular number or sequence of method steps. For example, FIG. 1 illustrates an exemplary method, but the blocks or steps could be re-arranged with steps removed, steps added, and/or steps altered.

While the invention has been disclosed with respect to a limited number of embodiments, those skilled in the art will appreciate, upon reading this disclosure, numerous modifications and variations. For example, various types of data can be utilized with embodiments in accordance with the present invention.

What is claimed is:

1) A computer method for presenting data, comprising:
computing a multi-level hierarchical structure for data;
computing a common color scale for the multi-level hierarchical structure;
using pixels to represent data records in the multi-level hierarchical structure; and
comparing different levels of the multi-level hierarchical structure using the common color scale to visually identify a cause of performance delays.

2) The method of claim 1 wherein the multi-level hierarchical structure includes plural separate X-Y graphs using multiple pixel bars.

3) The method of claim 1 further comprising drilling-down from the multi-level hierarchical structure to display multiple graphs that utilize bars with the common color scale.

4) The method of claim 1 further comprising displaying different colors to signify a location for the performance delays.

5) The method of claim 1 further comprising computing a base layer X-Y graph and plural sub-graphs of the base layer X-Y graph.

6) The method of claim 1 further comprising computing the common color scale with a range including a minimum time and a maximum time, the range being applied to each level of the multi-level hierarchical structure.

7) The method of claim 1 further comprising:
dividing the data into plural levels, each level having time-related events; and
using color to indicate time delays that occur for the time-related events.

8) The method of claim 1 wherein the common color scale is consistent and applied across each level of the multi-level hierarchical structure.

9) The method of claim 1 further comprising coloring pixels a first color to represent a first performance delay, and coloring pixels a second color to represent a second performance delay.

10) Computer-readable program code for causing a computer system to perform a method of displaying data, said method comprising:
computing plural hierarchical graphs for data;
arranging, using pixels, the data in the plural hierarchical graphs, with each pixel encoded with a portion of the data;
computing a color scale that is common for the plural hierarchical graphs; and
displaying the plural graphs, using the pixels and common color scale, to illustrate time-related performance delays in the data.

11) The computer-readable medium of claim 10 wherein the plural hierarchical graphs illustrate time to execute an event, and the common color scale extends between a minimum time and a maximum time.

12) The computer-readable medium of claim 10 wherein said plural hierarchical graphs comprise an X-axis and a Y-axis.

13) The computer-readable medium of claim 12 wherein the X-axis represents a data category and the Y-axis represents a data value.

14) The computer-readable medium of claim 10 wherein each pixel is encoded with a color.

15) The computer-readable medium of claim 14 wherein the pixels are encoded with a plurality of different colors.

16) A computer implemented method, comprising:
deriving a multi-level hierarchical structure for data;
computing a common color scale for the multi-level hierarchical structure;
using pixels to represent data records in the multi-level hierarchical structure; and
navigating through different levels of the multi-level hierarchical structure having the common color scale to visually identify a cause of performance delays.

17) The computer system of claim 16 wherein the multi-level hierarchical structure includes plural X-Y graphs using multiple pixel bars.

18) The computer system of claim 16 further comprising sharing common colors between the different levels of the multi-level hierarchical structure to visually identify the cause of performance delays.

19) The computer system of claim 16 wherein the performance delays include time delays for executing requests by users.

20) The computer system of claim 16 further comprising computing the common color scale with a range including a minimum time and a maximum time.
